(19) United States
(12) Patent Application Publication
(10) Pub. No.: US 2008/0229220 A1
(43) Pub. Date: Sep. 18, 2008

(54) MULTITHREADING ICONIC PROGRAMMING SYSTEM

(75) Inventor: Hua Jing, Beijing (CN)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(73) Assignee: AGILENT TECHNOLOGIES, INC., Loveland, CO (US)

(21) Appl. No.: 12/131,090

(22) Filed: Jun. 1, 2008

(30) Foreign Application Priority Data
Apr. 21, 2008 (CN) 200810095006.6

(51) Int. Cl. G06F 3/048

(52) U.S. Cl. 715/763

(57) ABSTRACT

An iconic network within a computer system is displayed on a display device. Multithreading execution of the iconic network is performed. The computer system receives user input to group icons of the iconic network into separate thread graphical blocks displayed on the display device. The computer system assigns the thread graphical blocks to separate threads of the operating system. The computer system executes the icons grouped in the separate thread graphical blocks by executing the separate threads of the operating system. Data associated with the icons of the iconic network is exchanged between the computer system and external electronic instruments through an instrument bus as the iconic network is processed.

### BACKGROUND OF THE INVENTION

An iconic programming system is a “programming-less” environment where programming is done by connecting graphical images of devices (icons), together with lines, to create an iconic network which represents a software program. The iconic programming system may be used in research and development test environments, where several different external electronic instruments are connected to test a system or device. Programming such a system requires instructions to cause the various external instruments to perform desired functions in order to operate as a system.

When an iconic programming system is used, each instrument is represented by a graphical icon, also called a graphical object, and the connections between the instruments are represented by connecting lines between the graphical icon images. Each device may have multiple input lines connecting from other devices, bringing data into the device for it to use during its execution. Each device may also have multiple output lines connecting to other devices, to pass its new or changed data on to the other devices in the program. In addition to graphical icons representing instruments in such a system, graphical icons are provided for programming functions, for example looping, IF-THEN statements, data analysis, data display, simulated instruments, etc. By combining instrument and programming icons, a user can create an iconic network involving the programmed operation of several instruments.

When the iconic network runs, each device may use the data on its input lines, modify it, and put the same or other data on its output lines for other devices to use.

Various features and components of an iconic network system are disclosed in the following U.S. patent applications which are assigned to the same assignee as the present invention: U.S. Pat. No. 5,313,575, U.S. Pat. No. 5,261,043, U.S. Pat. No. 5,377,318, U.S. Pat. No. 5,293,476, U.S. Pat. No. 5,325,481, U.S. Pat. No. 5,551,041, U.S. Pat. No. 5,313,574, U.S. Pat. No. 5,437,007, U.S. Pat. No. 6,016,143, U.S. Pat. No. 5,754,426, U.S. Pat. No. 6,816,914 and U.S. Pat. No. 6,862,030.

One problem in iconic programming systems is that there can be many graphical icons running simultaneously or seemingly simultaneously. This can result in slow processing of the system. Also, synchronous calls might be made to resources, such as the external instruments. These instrument calls can take a long time to complete. In a single-threaded application, a synchronous call effectively blocks, or prevents, any other task within the application from executing until the operation completes.

In order to understand Applicants' invention, it is helpful to understand “processes” and “threads” in computer operating systems as is known in the prior art.

Processes are often called “tasks” in embedded operating systems. A “process” is an instance of a computer program that is being sequentially executed. A computer program itself is just a passive collection of instructions, while a process is the actual execution of those instructions. The process is something that takes up time. In contrast, a computer program is stored in memory and is thus something that takes up space.

A process consists of (or is said to “own”) the following resources:

An image of the executable machine code associated with a program.

Memory (typically some region of the virtual memory), which includes the executable code, process-specific data (input and output), a call stack (to keep track of active subroutines and/or other events), and a heap to hold intermediate computation data generated during run time.

Operating system descriptors of resources that are allocated to the process, such as file descriptors (UNIX terminology) or handles (WINDOWS terminology), and data sources and sinks.

Security attributes, such as the process owner and the process' set of permissions (allowable operations).

Processor state (context), such as the content of registers, physical memory addressing, etc. The state is typically stored in computer registers when the process is executing, and in memory otherwise.

The operating system holds most of this information about active processes in data structures called process control blocks (PCB).

Several processes may be associated with the same program. For example, the opening up of two windows of the same program typically means two processes are being executed.

The operating system keeps its processes separated and allocates the resources they need so that they are less likely to interfere with each other and cause system failures (e.g. deadlock or thrashing). The operating system may also provide mechanisms for inter-process communication (IPC) to enable the processes to interact in safe and predictable ways.

A single computer processor executes only one instruction at a time. To allow users to run several programs at once, single-processor computer systems can perform time-sharing, whereby processes switch between being executed and waiting to be executed. In most cases this is done at a very fast rate, giving an illusion that several processes are executing at once. Using multiple processors achieves actual simultaneous execution of multiple instructions from different processes. The operating system executes multiple applications more efficiently by splitting the different processes between the separate processors (multiprocessors) or multi-cores.

For security reasons, most operating systems prevent direct inter-process communication (IPC), providing only mediated and limited functionality. However, the multiple threads within a process can run different instructions on much of the same resources and data. This is useful when, for example, it is necessary to make it seem that multiple things within the same process are happening at once (such as a spell check being performed in a word processor while the user is typing), or if part of the process needs to wait for something else to happen (such as a web browser waiting for a web page to be retrieved).

A thread in computer science is short for a “thread of execution”. Threads provide a way for an application or program to fork (or split) itself into two or more simultaneously (or pseudo-simultaneously) running tasks. Threads and processes differ from one operating system to another but, in general, a thread is contained inside a process and different threads of the same process share some resources while different processes do not. For example, threads in the same process can share the same memory and file resources. Threads usually do not own the resources except for a stack and a copy of the registers including the program counter.

Multiple threads share the same program code, operating system resources (such as memory and file access) and operating system permissions (for file access) as the process they belong to.

A process that has only one thread is referred to as a single-threaded process, while a process with multiple threads is referred to as a multi-threaded process. Executing the multi-threaded process is referred to as multithreading.

Multithreading is multitasking within a single application. It allows multiple threads of execution to take place concurrently within the same program, each thread processing a different transaction or message. Threads and processes differ from one operating system to another but, in general, a thread is contained inside a process and different threads of the same process share some resources while different processes do not.

More specifically, processes are typically independent, carry considerable state information, have separate address spaces and interact only through the system-provide inter-process communication mechanisms. Multiple threads, on the other hand, typically share the state information of a single process, and share memory and other resources directly. Context switching between threads in the same process is usually faster than context switching between processes.

Multiple threads can be executed in parallel on many computer systems. This multithreading generally occurs by time slicing (similar to time-division multiplexing), wherein a single processor switches between different threads, in which case the processing is not literally simultaneous, for the single processor is really doing only one thing at a time. This switching can happen so fast as to give the illusion of simultaneity to an end user. For instance, many PCs today only contain one processor core, but one can run multiple programs at once, such as typing in a document editor while listening to music in an audio playback program; though the user experiences these things as simultaneous, in truth, the processor quickly switches back and forth between these separate processes.

On a multiprocessor or multi-core system, threading can be achieved via multiprocessing, wherein different threads and processes can run literally simultaneously on different processors or cores. Multithreading allows multiple threads to exist within the context of a single process, sharing the process' resources but able to execute independently. This advantage of a multithreading program allows it to operate faster on computer systems that have multiple CPUs, CPUs with multiple cores, or across a cluster of machines. This is because the threads of the program naturally lend themselves to truly concurrent execution. In such a case, the programmer needs to be careful to avoid race conditions, and other non-intuitive behaviors. In order for data to be correctly manipulated, threads often need to rendezvous in time in order to process the data in the correct order. Threads may also require atomic operations (often implemented using semaphores) in order to prevent common data from being simultaneously modified, or read while in the process of being modified. Careless use of such primitives can lead to deadlocks.

Many modem operating systems directly support both time-sliced and multiprocessor threading with a process scheduler. The operating system kernel allows programmers to manipulate threads via the system call interface. Threads can be managed and scheduled by the kernel using preemptive multithreading which allows the operating system to determine when a context switch should occur. The disadvantage to preemptive multithreading is that the system may make a context switch at an inappropriate time, causing priority inversion or other bad effects which may be avoided by cooperative multithreading.

Threads can also be managed and scheduled using cooperative multithreading which relies on the threads themselves to relinquish control once they are at a stopping point. This can create problems if a thread is waiting for a resource to become available.

Programs can also implement threading by using timers, signals, or other methods to interrupt their own execution and hence perform a sort of ad hoc time-slicing. These are sometimes called user-space threads.

However, in the prior-art it has required difficult programming to allocate particular tasks among threads of processes. There has been no way for a user to graphically allocate tasks between threads of processes in an iconic programming language. It would be desirable to allow for the manual allocation of graphical icons between multiple threads.

### SUMMARY OF THE INVENTION

The present invention allows for the manual allocation of graphical icons of an iconic network between multiple threads of an operating system.

In more general terms an iconic network within a computer system is displayed on a display device. Multithreading execution of the iconic network is performed. The computer system receives user input to group icons of the iconic network into separate thread graphical blocks displayed on the display device. The computer system assigns the thread graphical blocks to separate threads of the operating system. The computer system executes the icons grouped in the separate thread graphical blocks by executing the separate threads of the operating system. Data associated with the icons of the iconic network is exchanged between the computer system and external electronic instruments through an instrument bus as the iconic network is processed.

### BRIEF DESCRIPTION OF THE DRAWINGS

Further preferred features of the invention will now be described for the sake of example only with reference to the following figures, in which:

FIG. 1 shows a block diagram of a computer system incorporating the present invention.

FIG. 2 shows an iconic network processed by the computer system of FIG. 1.

FIG. 3 shows an open thread graphical block window of FIG. 2.

FIG. 4 shows another open thread graphical block window of FIG. 2.

FIG. 5 shows an open “Properties” window for the thread graphical block of FIG. 3.

FIG. 6 is a flow chart of the method for executing the iconic network of FIG. 2.

### DETAILED DESCRIPTION

The following description is of the best presently contemplated mode of carrying out the present invention. This description is not to be taken in a limiting sense but is made merely for the purpose of describing the general principles of the invention. The scope of the invention should be determined by referencing the appended claims.

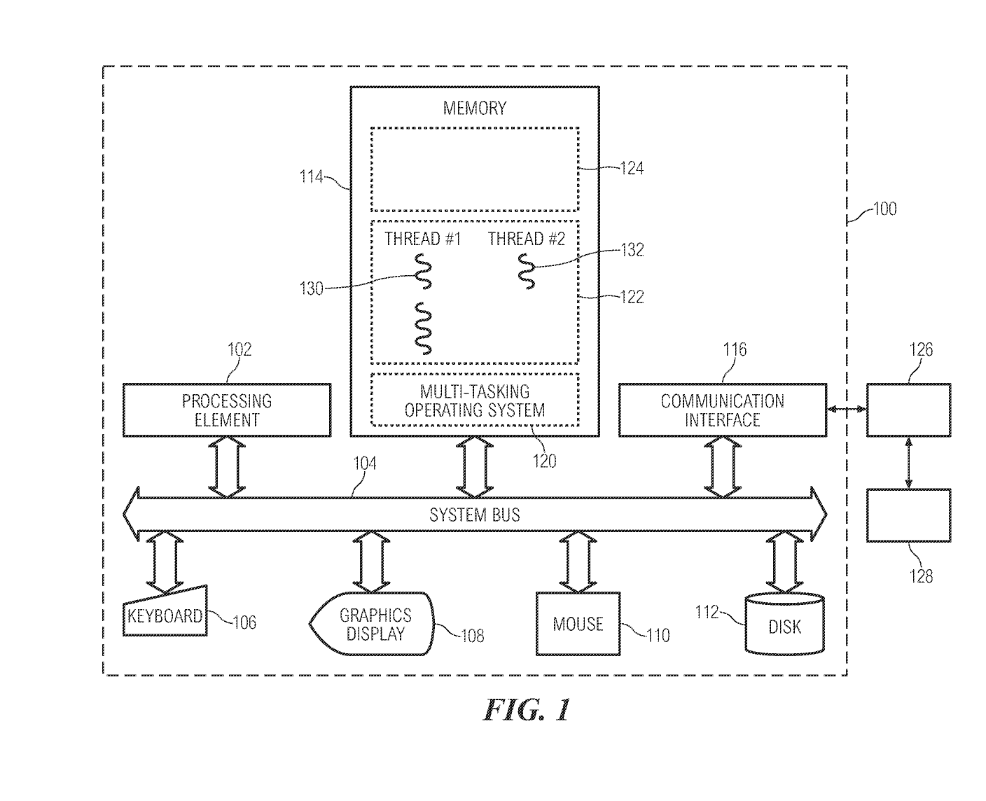

FIG. 1 shows a block diagram of a computer system incorporating the present invention. A computer system 100 contains a processing element 102 and memory 114 which connect to the other components of the system through a system bus 104. A keyboard 106 allows a user to input textual data to the system, and a mouse 110, or more generally any pointing device, allows a user to input graphical data to the system. A display device 108 allows the system to output text and graphical information to the user. The display device 108 can be a single computer monitor, multiple computer monitors, a projector, a screen or in general any device capable of displaying part or all of an iconic network. A disk 112 is used by the system to store the software of the iconic programming system environment, as well as the user-defined iconic network. A communications interface 116 is used to create a communications network which allows the computer and iconic programming environment to communicate with other computers and other environments. For example, the communication thorough the communications interface 116 can be to one or more instrument 126 which can be any external test and measurement equipment, for example. Also shown is an item to be measured 128 which can be any material, device or system to be measured by the one or more instrument 126.

A multitasking operating system 120, stored in the memory 114, can control a plurality of processes, here illustrated by a process 122 and a process 124. Processes 122 and 124 can each include the iconic programming processes and each can also include multiple threads. Two threads 130, 132 of the operating system 120 are illustrated within the process 122 as an example. Similar threads can execute within the process 124. In other embodiments there is only a single process running multiple threads, and in such embodiments the operating system might not be a multitasking operating system.

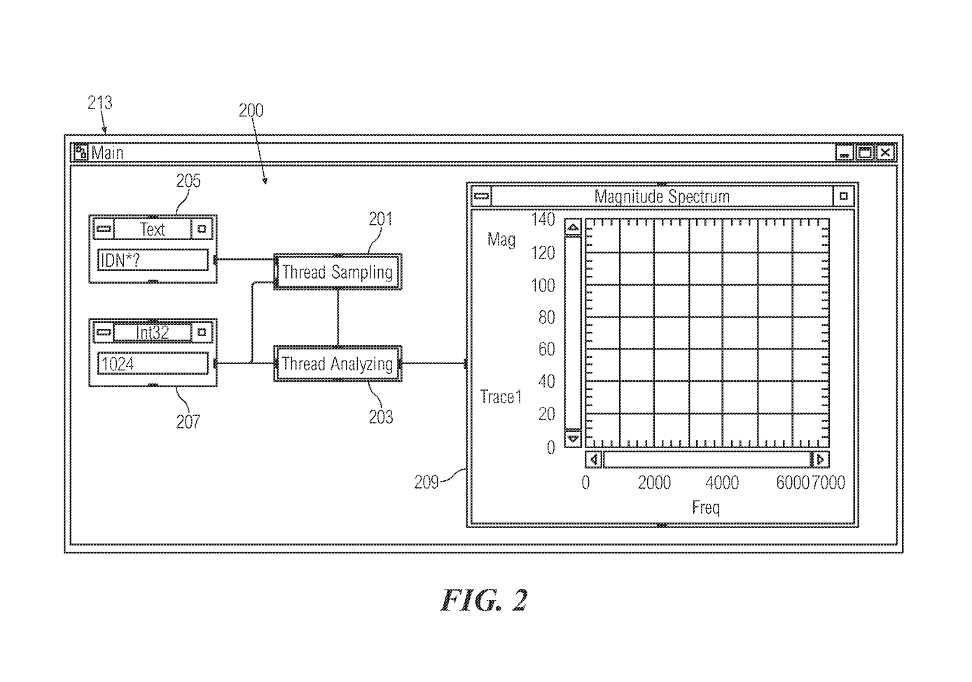

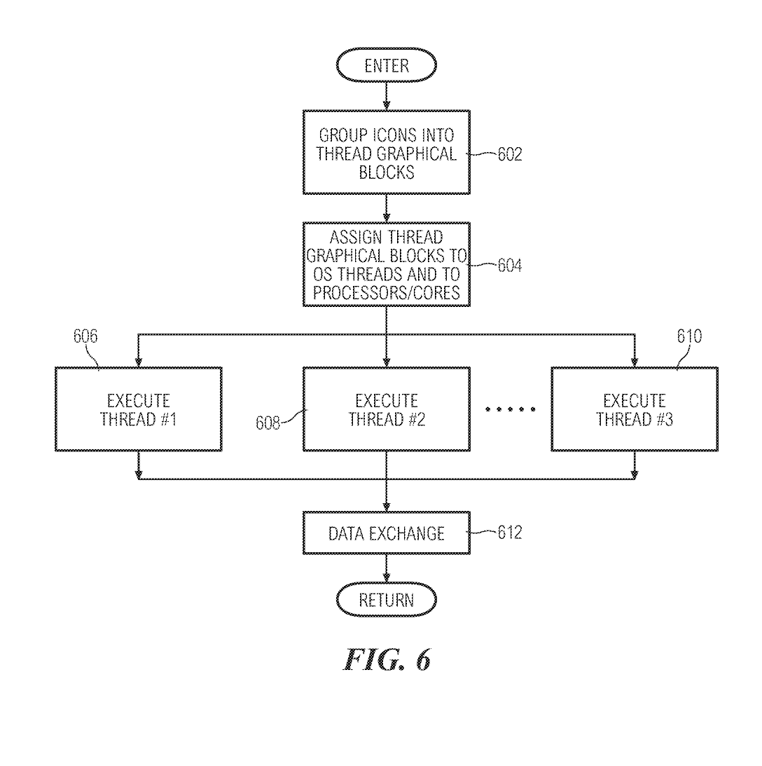

A first example of the present invention is described with reference to FIG. 2 showing an iconic network 200 within a window “Main” 213. Additionally, FIG. 6 shows a flowchart for the method of multithreading execution of an iconic network of the present invention such as an iconic network which includes the iconic network 200 of FIG. 2.

As shown in FIG. 2, the iconic network can include an iconic network thread graphical block, or thread block 201 labeled as “Thread-Sampling” and also an iconic network thread graphical block, or thread block 203 labeled as “Thread-Analyzing”. Any number of one or more of these thread blocks can be included in the present invention. Also shown in this iconic network 200 is a “Text” box 205, an “Int32” box 207, and a display device 209 labeled as “Magnitude Spectrum”. The display device 209 displays the data after it has been sampled and analyzed. The blocks are connected by connecting lines, such as a connecting line 211. The “Text” box 205 and “Int32” box 207 allow the user to exchange data through the inputs and outputs.

A user can drag or otherwise create within the thread blocks any of the graphical icons representing instruments in a system or graphical icons for programming functions, for example. The thread blocks can moreover include any combinations of these graphical icons as is understood in the art. Thus, generally, the thread blocks can include any iconic network or sub-network.

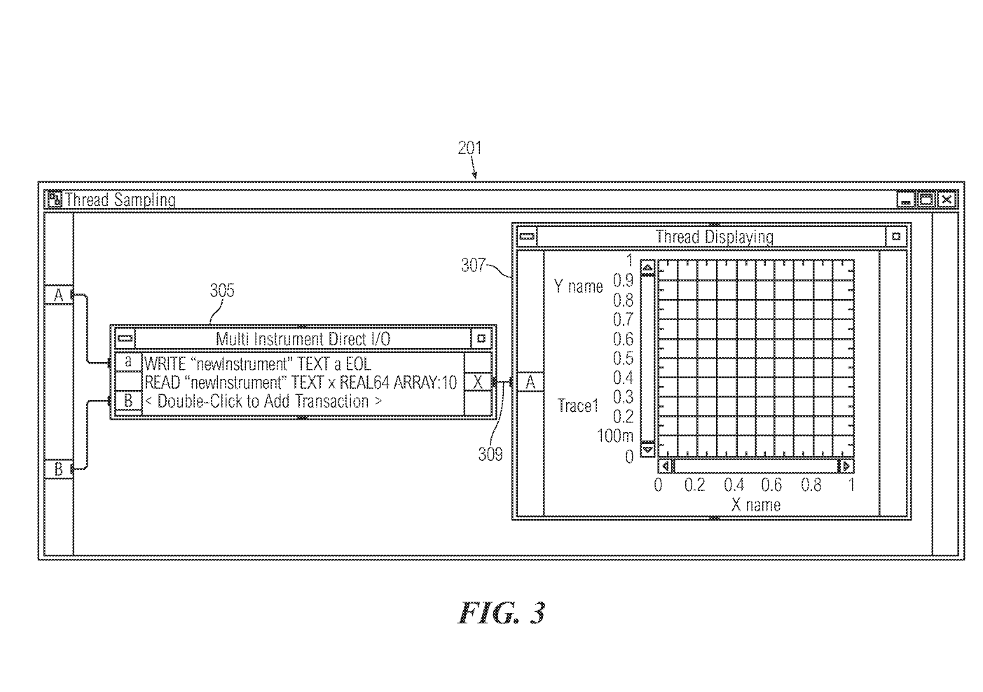

FIG. 3 shows the “Thread-Sampling” thread block 201 of FIG. 2 as an open window containing a graphical icon 305 labeled “Read Sample Data” and a graphical icon 307 labeled “XY Trace” to perform acquisition or sampling of data from the instrument 126 which can be measuring the item 128 (see FIG. 1). The graphical icons 305, 307 communicate via a connecting line 309. The use of such connected graphical icons for sampling of data is known in the art.

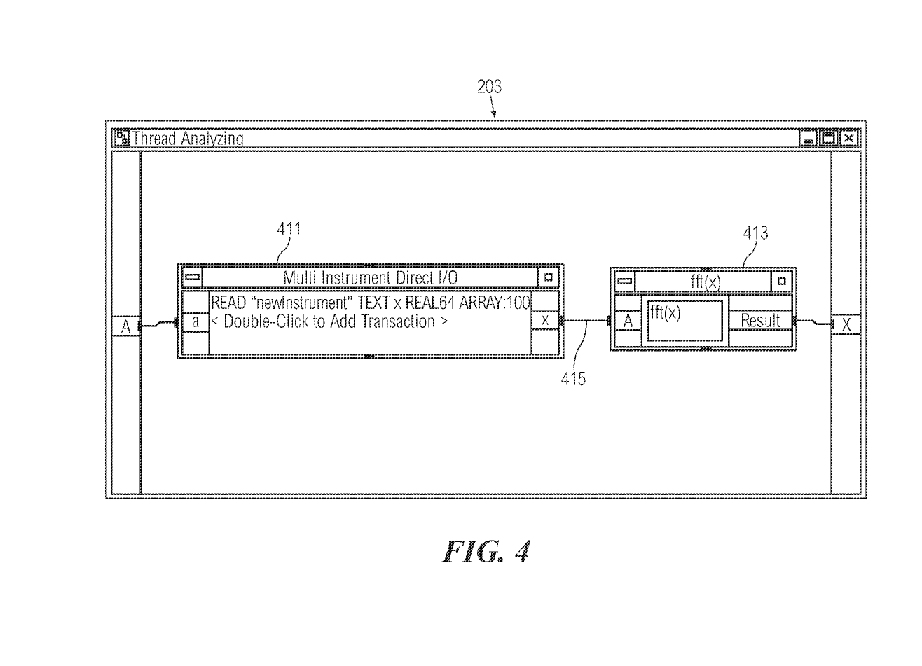

FIG. 4 shows the “Thread-Analyzing” thread block 203 of FIG. 2 as an open window containing a graphical icon 411 labeled “MultiInstrument Direct I/O” and a graphical icon 413 labeled “fft(x)” to perform analysis of data from the instrument 126 which can be measuring the item 128 (see FIG. 1). The graphical icons 411, 413 communicate via a connecting line 415. Again, the use of such connected graphical icons for the analysis of data is also known in the art.

The details of the particular iconic network or sub-network within the tread blocks is not important since any iconic network or sub-network executable by the operating system 120, multitasking or otherwise, and running on the computer system 100, is permissible within the thread blocks.

In the example of FIG. 2, the connected graphical icons 305, 307 within the “Thread-Sampling” thread block 201 can be executed as the thread 130 in FIG. 1, and the connected graphical icons 411, 413 within the “Thread-Analyzing” thread block 203 can be executed as the thread 132. The threads are within the same process 122 and are thus executed in a multithreading manner.

FIG. 2 also includes the connecting line 211 for connecting the thread blocks 201, 203. The connecting line 211 allows the user to determine the execution sequence of the threads. When there is no connecting line 211, the two thread objects will run simultaneously. When the connecting line 211 is used as illustrated in the figure, the Thread-Analyzing” thread block 203 can only be executed after the execution of the “Thread-Sampling” thread block 201.

The threads 130, 132 running the graphical icon threads 201, 203, respectively, share the state information of the process 122, and share memory and other resources directly. The resources shared by the threads 130, 132 can include:

An image of the executable machine code associated with the program.

Memory (for example, some region of the virtual memory), which includes the executable code, process-specific data (input and output), a call stack (to keep track of active subroutines and/or other events), and a heap to hold intermediate computation data generated during run time.

Operating system descriptors of resources that are allocated to the process, such as file descriptors (UNIX terminology) or handles (WINDOWS terminology), and data sources and sinks.

Security attributes, such as the process owner and the process' set of permissions (allowable operations).

Processor state (context), such as the content of registers, physical memory addressing, etc. The state is typically stored in computer registers when the process is executing, and in memory otherwise.

Different threads can also have registers that are not shared between threads.

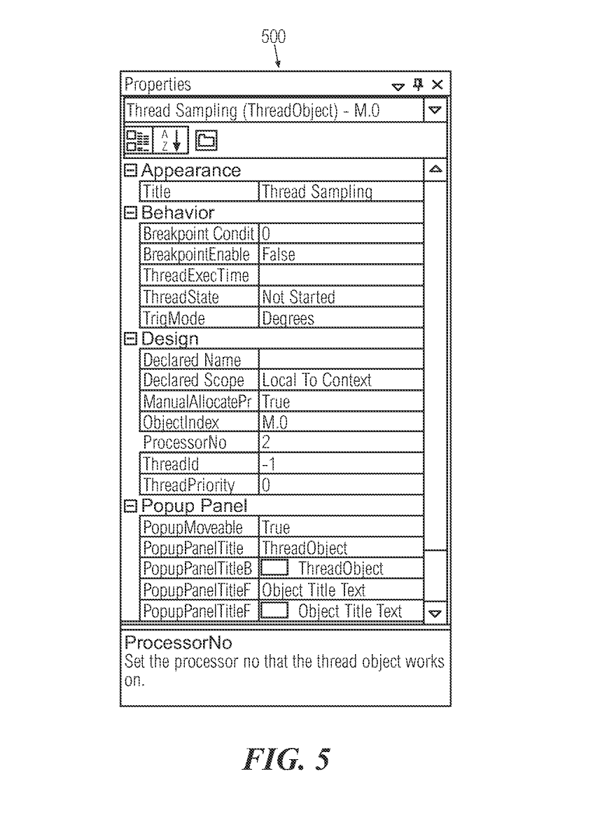

FIG. 5 illustrates a “Properties” window 500 that can be opened for the “Thread Sampling” thread graphical block 20 1, or for any other thread graphical block. This block allows a user to assign the thread, for example the thread 130 or 132, to different or the same processors or cores. Assigning the threads 130 and 132 to separate processors or cores allows for true simultaneous processing of the threads. In the given example, there can be two processing elements 102. The user assigns the “Thread-Sampling” thread block 201, and thus the thread 130, to a “ProcessorNo”=2 of the processing elements 102. The user does this by entering the number “2” for “ProcessorNo”.

Another “Properties” window (not shown) can be opened for the “Thread Analyzing” thread graphical block 203 and the user then assigns the “Thread Analyzing” thread block 203, and thus the thread 132, to a “ProcessorNo”=1 of the processing elements 102. The user does this by entering the number “1” for “ProcessorNo”.

The same process can be repeated for any other thread blocks in the iconic network 200.

The iconic network 200 is processed by the processing element 102 and displayed on the display device 108 of FIG. 1. Commands and data are communicated between the graphical icons of the iconic programming process 122 and the instruments 126 through the communication interface 116 of FIG. 1.

Returning to the flowchart of FIG. 6, at STEP 602, a user provides input using the keyboard 106 or mouse 110 to group icons 305, 307, 411, 413 of the iconic network 200 into separate ones of the thread graphical blocks 201, 203 displayed on the display device 108.

At STEP 604 the operating system 120 assigns the thread graphical blocks 201, 203 to separate threads 130, 132 of the operating system 120. Also, using the “Properties” window 500, the user can assign the thread graphical blocks to a particular thread and to a particular processor or core when the system 100 has multiple cores or multiple processors.

At STEPS 606, 608, 610 the operating system 120 executes the icons 305, 307, 411, 413 grouped in the separate thread graphical blocks 201, 203 by executing the separate threads 130, 132 of the operating system in a multithreading manner.

At STEP 612 data associated the icons of the iconic network 200 is exchanged between the computer system 100 and external electronic instruments 126 through an instrument bus 116 as the iconic network 200 is processed.

Embodiments of the invention can include two or more thread graphical blocks executed by two or more threads of the operating system.

The threads of the operating system and their corresponding thread graphical blocks can be executed in a multithreaded manner by executing them simultaneously by splitting the threads between separate processors (multiprocessors) or multi-cores. Or, they can be executed in a multithreading manner using a single-processor time-sharing can be performed by having the operating system switch between the treads at a very fast rate, giving an illusion that several threads executing at once.

In the foregoing specification, the invention has been described with reference to specific exemplary embodiments thereof. The specification and drawings are, accordingly, to be regarded in an illustrative sense rather than a restrictive sense.

1. A method for multithread execution of an iconic network within a computer system having an operating system, the iconic network displayed on a display device, comprising the steps of:
receiving user input to group icons of the iconic network into separate thread graphical blocks displayed on the display device;
assigning the thread graphical blocks to separate threads of the operating system;
executing the icons grouped in the separate thread graphical blocks by executing the separate threads of the operating system; and
exchanging data associated the icons of the iconic network between the computer system and external electronic instruments through an instrument bus as the iconic network is processed.

2. The method of claim 1, further comprising the step of:
displaying a window associated with one of the thread graphical blocks;
receiving user input to the window to assign a thread, to which a thread graphical block has been assigned, to one of multiple cores of the processor.

3. The method of claim 1, further comprising the step of:
displaying a window associated with one of the thread graphical blocks;
receiving user input to the window to assign a thread, to which a thread graphical block has been assigned, to one of multiple processors of the computer system.

4. The method of claim 1, further comprising the step of receiving user input to connect at least two of the thread blocks using a connecting line, the connecting line providing instructions to execute one of the thread blocks after another of the thread blocks.

5. The method of claim 1, wherein the operating system processes the separate threads in a multithreading manner by time-sharing a single-processor.

6. The method of claim 1, further comprising the step of communicating between the thread graphical blocks using a communication channel between the thread graphical blocks.

7. An iconic programming system for communicating with test and measurement instruments comprising:
thread graphical blocks for display on a display device of the iconic programming system;
a user input device for allowing a user to group icons of the iconic network into the thread graphical blocks;
an operating system of the iconic programming system for assigning the thread graphical blocks to separate threads of the operating system and for executing the icons by executing the separate threads of the operating system.

8. The system of claim 7, wherein the computer system has a processor consisting of multiple cores and further comprising one or more windows displayed on the display device for receiving user input to assign the execution of threads, to which thread graphical blocks have been assigned, to different ones of the multiple cores.

9. The system of claim 7, wherein the computer system has multiple processors and further comprising a window displayed on the display device for receiving user input to assign the execution of threads, to which thread graphical blocks have been assigned, to different ones of the multiple processors.

10. The system of claim 7, further comprising a connecting line connecting at least two of the thread blocks, the connecting line providing instructions to execute one of the thread blocks after another of the thread blocks.

11. The system of claim 7, wherein the system includes a processor controlled by the operating system for processing separate threads in a multithreading manner by time-sharing the processor.

12. The system of claim 7, further comprising a communication channel between the thread graphical blocks for allowing communication between the thread graphical blocks.
